(19) United States
(12) Patent Application Publication
(10) Pub. No.: US 2014/0052543 A1
(43) Pub. Date: Feb. 20, 2014

(54) SYSTEM AND METHOD FOR PROVIDING USER SELECTED CONTENT VIA PUBLISHERS

(71) Applicants: Woo Jin Kim, San Francisco, CA (US); Christopher Kenneth Harris, Santa Clara, CA (US)

(72) Inventors: Woo Jin Kim, San Francisco, CA (US); Christopher Kenneth Harris, Santa Clara, CA (US)

(73) Assignee: Google Inc., Mountain View, CA (US)

(21) Appl. No.: 13/588,650

(22) Filed: Aug. 17, 2012

(51) Int. Cl. G06Q 30/00; G06F 15/16

(52) U.S. Cl. 705/14.69; 709/217; 709/206; 705/14.4

(57) ABSTRACT

Apparatus and method for managing a user's desire to see user selected content along with a publisher's content on a web page. The apparatus and method manage the displaying of the user selected content on the web pages along with managing revenue and payments for the display of the user selected content.

### BACKGROUND

Content providers, such as publishers, generally operate to provide content for display on web pages of Internet websites or via mobile applications. The content is typically accompanied by advertisements.

Accordingly, there is a need for a system whereby a user can determine what accompanies the content provided by the content providers to the Internet web pages viewed and mobile applications used by the user.

### SUMMARY

Various embodiments disclosed herein are generally directed to an apparatus and method for managing user selected content displayed along with publisher content on publisher's web pages.

In accordance with some embodiments, a computer-implemented method is provided. The method comprises defining a layout for a content display of a publisher having a defined layout, the defined layout having a publisher content element and at least one content slot adapted to display at least one content item. The method further comprises receiving a request for the content display from a network accessible device, the network accessible device having an associated user. The at least one content item is identified for display in the at least one content slot, the at least one content item preselected by the associated user of the network accessible device or a third party user. Data is then transferred to the network accessible device to display the content display arranged in accordance with the defined layout with the at least one content item displayed in the at least one content slot.

In accordance with another embodiment, another computer-implemented method is provided. This method comprises receiving, in a server memory, a request from a network accessible device to transfer at least one content item for display in at least one content slot of a content display of a publisher. At least one selected content item is identified from a plurality of available content items. The at least one selected content item is transferred, across a network, for display in the at least one content slot of the content display on the device. Funds from a user of the network accessible device are transferred to the publisher of the content display in an amount at least equal to an amount the publisher would have received responsive to display of a second content item in said at least one content slot.

In accordance with a further embodiment, an apparatus or system is disclosed. The apparatus includes a content display layout engine adapted to transfer data to a network accessible device to display a content display of a publisher on said device, the content display having at least one content slot. The apparatus also includes a user selected content server adapted to transfer to the device an associated content item for display in the at least one content slot of the content display, the at least one content item selected by the user

These and other features and advantages which may characterize various embodiments can be understood in view of the following detailed discussion and the accompanying drawings.

### BRIEF DESCRIPTION OF THE DRAWINGS

FIG, 1 provides a functional block representation of a network-based system in accordance with various embodiments.

FIG. 2 provides another functional block representation of the network-based system in accordance with various embodiments.

FIGS. 3A-3D represent different example web page layouts that may be displayed on the user device in FIGS. 1 and 2.

FIG. 4 illustrates a data exchange sequence in which requested user selected content is delivered to the user device.

FIG. 5 is a flow chart that summarizes steps that may be carried out in accordance with various embodiments.

FIG. 6 provides a functional block representation of revenue transfer in accordance with various embodiments.

### DETAILED DESCRIPTION

The present disclosure generally relates to a system for managing the display of user selected content in a content display of an Internet web page and/or a mobile application of a publisher on a user network accessible device.

Content displays of Internet web pages or mobile applications have a defined layout of all the content that is displayed when a user views the web page or mobile application. The defined layout can include a publisher content element and at least one content slot that is adapted to display a content item. The content item can be anything displayable on a web page or mobile application that is not the publisher's content (or publisher content element) and visible on a user network accessible device.

In one embodiment, the content slot is adapted to display an advertisement (ad) and the content item is displayed on the web page or mobile application in lieu of the ad. The content item displayed can be user selected content selected by a user who sees the content item or by a third party user who selects the user selected content for another user to see.

One way revenue is generated for publishers is by allowing ads to be placed on the content display of the the web page or mobile application of the publisher. When user selected content is selected to fill the content slot of the web page or mobile application in lieu of an ad, the revenue of the publisher of the the web page or mobile application is replaced by the third party user who pays to have the user selected content displayed on the content display.

In one embodiment, the user or third party user who would like to have user selected content displayed on the publisher's web page or mobile application along with the publisher content element provides revenue to the publisher via a revenue transfer engine. The publisher receives the revenue the publisher would have otherwise received for displaying the ad on the web page or mobile application.

Revenue can be generated from users to pay for the user selected content to be displayed on the content display of the web page or mobile application of the publisher in a number of different ways. For example, the user can pay a periodic fee, such as a daily, monthly or yearly fee, or they could have a pay-as-you-go account. It should be understood and appreciated that any system could be implemented to facilitate the payment of revenue from users to publishers for the display of user selected content on the content display on the web page or mobile application.

In one embodiment, users sign up and create an account to enable user selected content to be displayed on the web page or mobile application of the publisher in lieu of the ads. In another embodiment, users provide user profile information to the system that manages the user selected content. The user profile information can be any information requested by the system and/or provided by the user. It should be understood and appreciated that users can opt in or out of this system at any time.

The user selected content (content item) can be automatically generated from profile information supplied by the user to the system that manages the user selected content. The user selected content can be specifically requested content from the user. For example, the user selected content could be a game, calendar information, social network information feeds, photo streams, news feeds, sports information, etc. The user selected content can also be personalized messages for one user to see but sent from a third party user. Furthermore, the user selected content can be content transferred from a second publisher. In scenarios where the user or third party user selects the user selected content, the system may have a pre-screening process/engine to ensure appropriate content was being shown on the publisher's web page or mobile application.

In another embodiment, the user selected content can be content made available by a content providing service. This content made available by the content providing service can be content which rights to have already been obtained. The user selected content could also be predetermined messages that can be selected (e.g., Happy Birthday!!). In a further embodiment, the user may select multiple forms, types, and/or categories of user selected content and these various categories are randomly shown to the user via the web page or mobile application used/visited by the user.

In another embodiment, the system possesses privacy and security measures to ensure that users only see user selected content from trusted and authorized parties. The system can also have an option to prevent identifiable personal information regarding the user from being displayed as the user selected content.

These and other features and benefits can be understood beginning with a review of FIG. 1 which depicts a network-based, user selected content transfer system 100 constructed and operated in accordance with various embodiments.

The system incorporates a number of active elements including a publisher server 102, an advertisement (ad) server 104, a user selected content server 106, and at least one user network accessible devices 108, all of which communicate over one or more networks 109.

The publisher server 102 may represent a web page hosting server or similar system adapted to display one or more web pages from a website of a publisher (e.g., source of the website). The ad server 104 services ad requests to display ads in conjunction with the web pages. The user selected content server 106 services requests to identify what user selected content replaces which ads for a given web page. While the respective publisher, ad and user selected content servers 102, 104 and 106, a re shown as separate modules, it will be appreciated that these functions can be readily combined; for example, the user selected content server operation can be incorporated into the ad server, etc.

The user devices 108 represent individual network accessible devices, such as desktop computers, laptop computers, smart phones, tablets, gaming consoles, televisions, and similar devices adapted to interact with the publisher, ad and user selected content servers 102, 104 and 106.

The network 109 can take any suitable form(s) such as a wide area network (WAN), a local area network (LAN), a broadband wireless network, etc. It will be appreciated that other elements may be incorporated into the system 100, as desired.

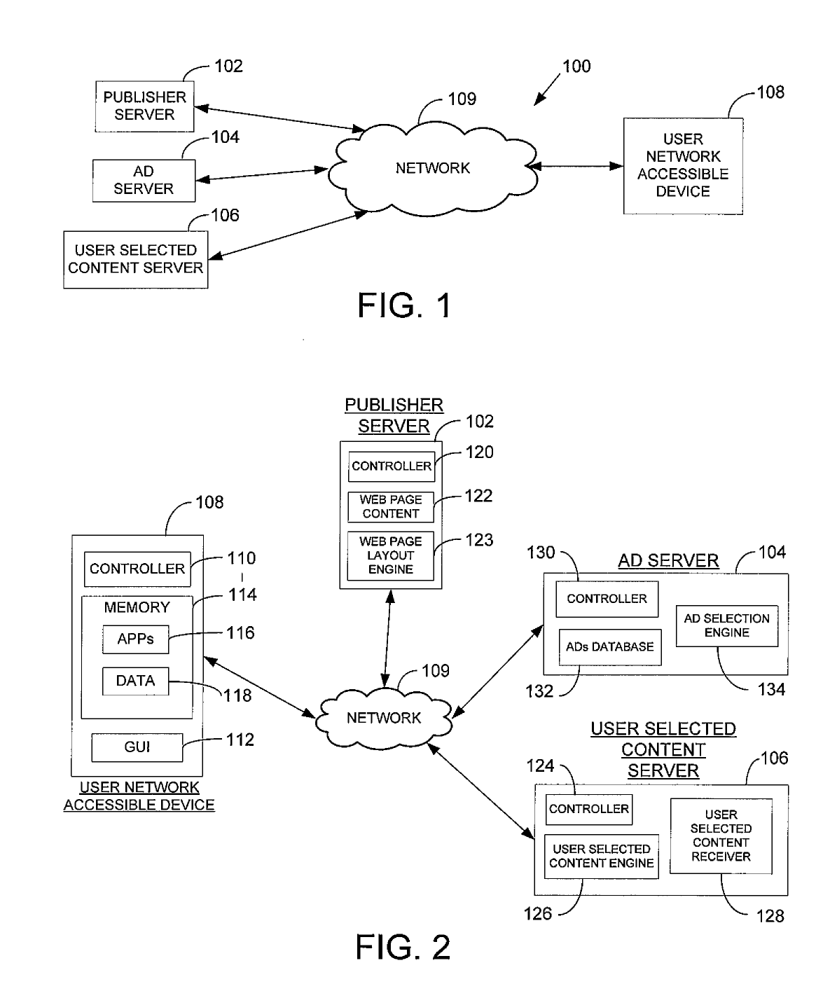

FIG. 2 shows aspects of the system 100 of FIG. 1 in accordance with some embodiments. A selected network accessible (user) device 108 from FIG. 1 is contemplated as comprising a desktop computer (personal computer, PC) with a high speed Internet connection to communicate with the network 109. This is merely for purposes of providing a concrete example and is not limiting.

The user device 108 includes a controller 110, a graphical user interface (GUI) 112 and memory 114. The controller 110 may be a programmable processor that uses associated operating system programming and application software (e.g., a web browser) in the memory to interact with the network 109. The GUI 112 may include a display monitor, keyboard, mouse, etc. The memory 114 may represent a hierarchical memory structure made up of various memory devices within the user device 108, including such elements as a non-volatile main memory (e.g., disc memory, solid-state drive, etc.), data transfer buffer, local processor (L1-L3) cache, etc. The memory 114 stores various operational modules including applications (apps) 116 and application (app) data 118.

Various ways in which web page data can be transferred for display on the GUI 112 will be discussed in greater detail below. At this point, it will be understood that the user of the device 108 opens the web browser application or mobile application and requests a selected web page or application from the publisher. A controller 120 of the publisher server 102 processes the request in conjunction with the user selected content server 106 to deliver content for the selected web page from a web page content store 122. The publisher server 102 can further include a web page layout engine 123 that is adapted to transfer data to the user network accessible device 108 to display a web page or the publisher.

The ad server 104 includes a controller 130, an ADs database 132 and an AD selection engine 134 to select which ADs would be placed in the one or more content slots of web pages and/or mobile applications. The ad selection engine 134 can also identify an amount of revenue responsive to an automated ad auction for the content slot.

The user selected content server 106 includes a controller 124, a user selected content engine 126 and a user selected content receiver 128. The user selected content engine 126 generally operates to identify a content display for a web page and determine the content slots of a web page or mobile application to place the user selected content. The user selected content receiver 128 receives the user selected content from users can generate models for an objective function of the website (e.g., increased revenue) in order to assess predicted user behavior, and this model can be used as part of the layout selection process.

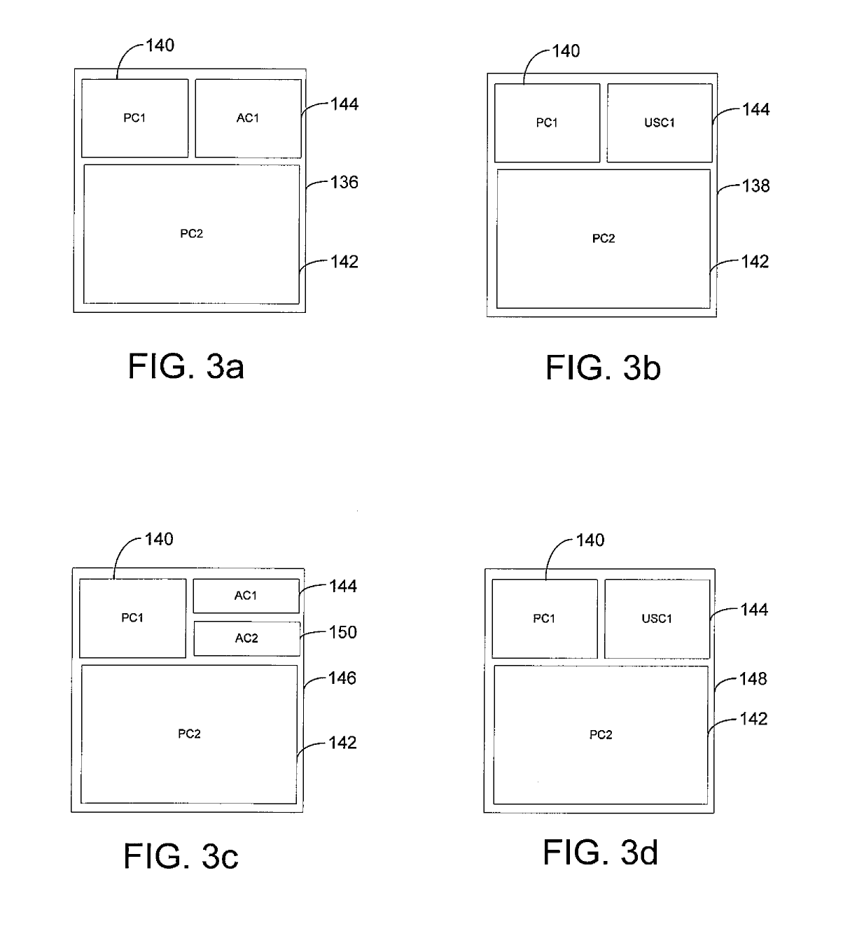

FIGS. 3A-3D illustrate various alternative layouts for web pages having at least one publisher content element and at least one content slot adapted to display a content item. FIG. 3A shows a first layout 136, and FIG. 3B shows a second layout 138. The first layout 136 shows a typical web page layout. The layouts in FIGS. 3A and 3B include a first publisher content element 140 (PC₁), a second publisher content element 142 (PC₂), and a first content slot 144 to display a content item. In FIG. 3A, the first content item in the first content slot 144 is advertising content (AC₁). In FIG. 3B, the content item in the first content slot 144 is user selected content (USC₁), which, based on the user's request, is displayed in lieu of the advertising content.

FIG. 3C shows a third layout 146, and FIG. 3D shows a fourth layout 148. The third layout 146 shows another typical web page layout. It should be understood and appreciated that there are numerous layouts for web pages and these shown herein are only intended to be exemplary embodiments. The layouts in FIGS. 3C and 3D also include the first publisher content element 140 (PC₁), the second publisher content element 142 (PC₂), and the first content slot 144. The layout in FIG. 3C further includes a second content slot 150 (AC₂). Similar to the content item in the first content slot 144 in FIG. 3A being advertising content, the content item in the second content slot 150 is also advertising content. In FIG. 3D, the advertising content in the first content slot 144 and the second content slot 150 shown in FIG. 3C is replaced by requested user selected content and is displayed in the first content slot 144. It should be understood and appreciated that a web page can have any number of content slots filled with advertising content (i.e. one to n number of slots) and these content slots can be replaced with any number of content slots filled with user selected content. For example, a web page can have four content slots for advertising and those four content slots can be combined to make one or two content slots filled with user selected content. The opposite can also be the case. In this example, a web page can have a single content slot filled for advertising content and this content slot can be expanded to two or more content slots filled with user selected content.

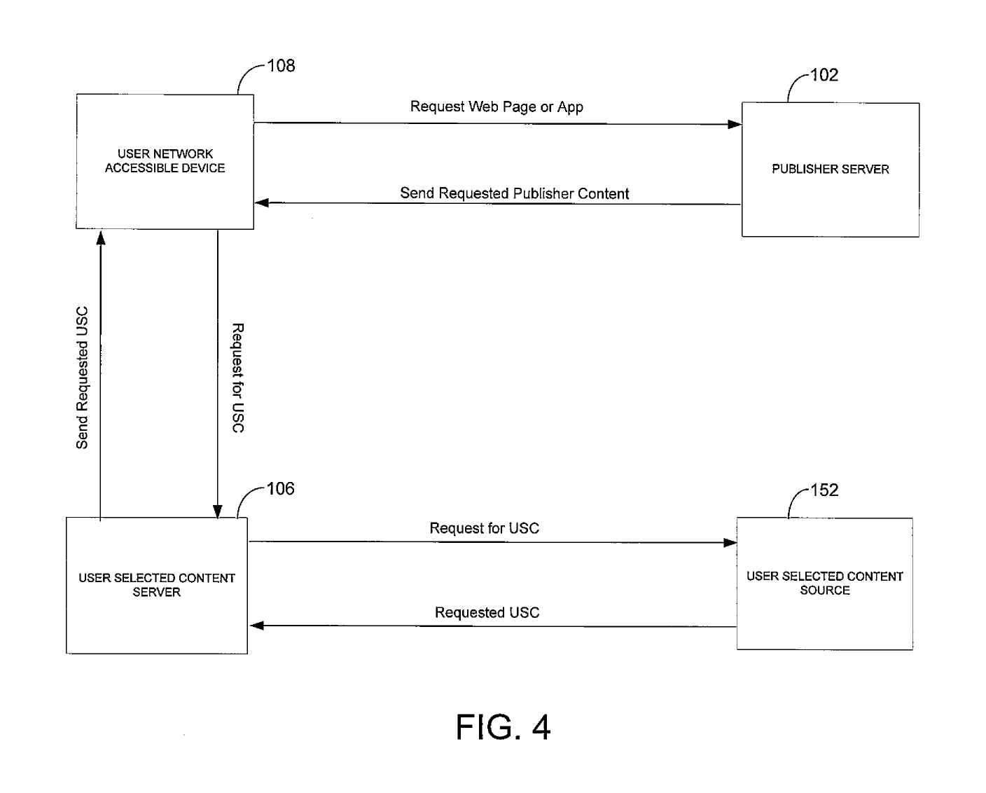

FIG. 4 shows a first sequence in which the user network accessible device 108 requests a web page or mobile application (or content) from the publisher server 102. Once a request for a web page or mobile application is made, another request for user selected content is made by the user network accessible device 108 from the user selected content server 106. The request for user selected content is then sent to a user selected content source 152 via the user selected consent server 106. The requested user selected content is then sent from the user selected content source 152 to the user network accessible device 108 via the user selected content server 106 to be displayed in lieu of advertising content in the content slots of the web page requested from the publisher server 106. The requested web page or mobile application (content) is then sent to the user network accessible device 108 and the web page includes the user selected content instead of the typical advertising content that is generally displayed with the publisher content element.

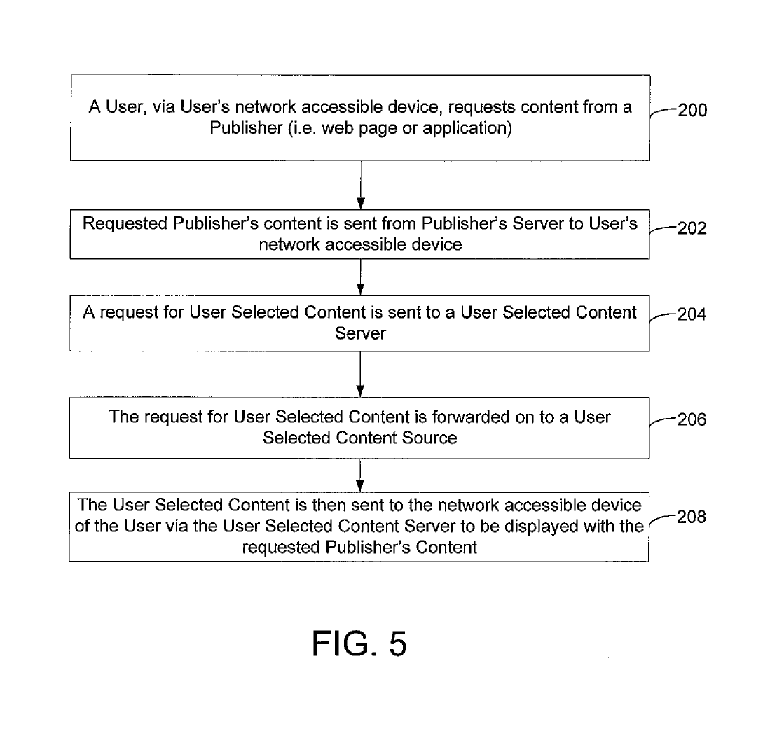

FIG. 5 provides a flow chart for the system managing the requesting of user selected content. A user, via the user network accessible device 108, requests content from the publisher (i.e. web page or application) via step 200. As discussed above, this can be carried out by the user of the device 108 opening a web browser or other application and issuing an appropriate URL or other data exchange operation. In another step 202, the requested publisher's content is sent form the publisher server 102 to the user network accessible device 108. A request for user selected content is sent to the user selected content server 106 at step 204. The next step 206 is for the request for user selected content to be forwarded on to the user selected content source 152. In step 208, the user selected content is then sent to the network accessible device 108 of the user via the user selected content server 106 to be displayed with the requested publisher content requested in step 200.

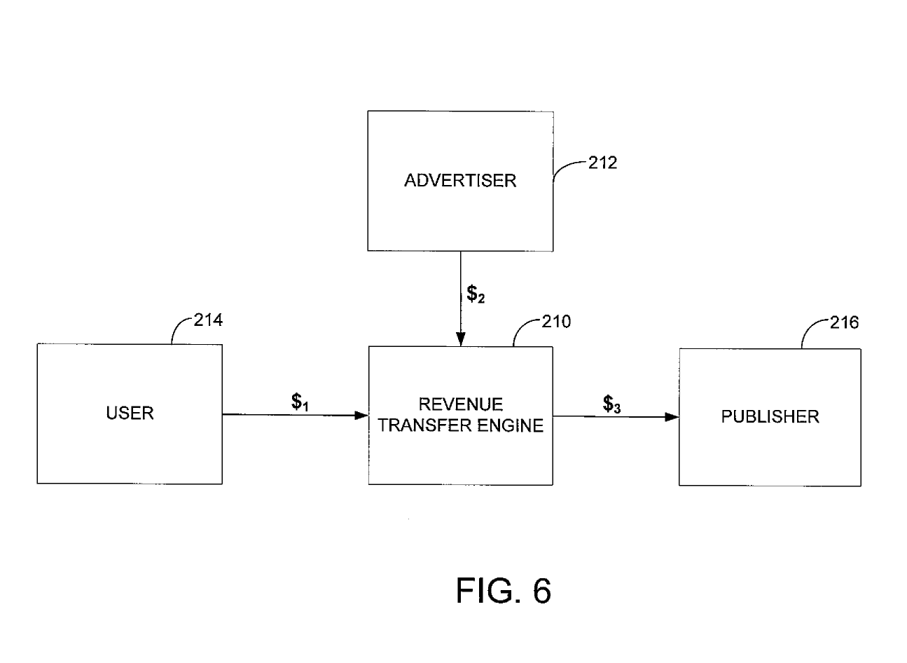

FIG. 6 provides a depiction of how a revenue transfer engine 210 is implemented to facilitate the revenue transfer between advertisers 212, users 214 and publishers 216. When ads are provided in the content slots of web pages, revenue ($₂) is paid from the advertiser 121 to the the revenue transfer engine 210 and revenue ($₃) is transferred to the publisher 216. When user selected content is requested from the user 214, the user 214 provides revenue ($₁) to the revenue transfer engine 210 and revenue ($₃) is transferred to the publisher 216. When user selected content is requested by a user in lieu of advertising content, the revenue transfer engine 210 identifies the revenue payable to the publisher 216 and the user 214 must provide to the publisher 216 the same amount of revenue the publisher 216 would have realized from the advertiser 212.

The revenue the user 214 would have to pay to the publisher 216 depends on what the advertiser 212 would have to pay to the publisher 216. The revenue the advertiser 212 would have paid to the publisher 216 can be calculated by predicting the likelihood of a user clicking on an advertisement displayed on a web page. The revenue paid by the advertiser 212 to the publisher 216 can also be determined by an automated auction to select a third party content item to display in the content slot of a web page or an automated ad auction carried out by the ad server 104.

It is to be understood that even though numerous characteristics and advantages of various embodiments of the present disclosure have been set forth in the foregoing description, together with details of the structure and function of various embodiments, this detailed description is illustrative only, and changes may be made in detail, especially in matters of structure and arrangements of parts within the principles of the present disclosure to the full extent indicated by the broad general meaning of the terms in which the appended claims are expressed.

What is claimed is:

1. A computer-implemented method comprising:
receiving a request for a content display from a network accessible device, the network accessible device having an associated user, and the content display having a publisher content element and at least one content slot adapted to display at least one content item;
identifying the at least one content item for display in the at least one content slot, the at least one content item preselected by the associated user of the network accessible device or a third party user; and
transferring data to the network accessible device to display the content display with the at least one content item displayed in the at least one content slot.

2. The method of claim 1, in which the at least one content item is selected from a pool of available content items responsive to profile information associated with the user.

3. The method of claim 1, in which the at least one content slot is further adapted to display an advertisement from an ad server, and the at least one content item is displayed in lieu of an advertisement from the ad server.

4. The method of claim 3, further comprising identifying an amount of revenue payable to the publisher from an advertiser for display of an advertisement associated with the advertiser in the at least one content slot on the network accessible device, and transferring said amount of revenue from the user of the network accessible device to the publisher.

5. The method of claim 1, in which a server transfers the defined layout for the content display and the at least one content item for the at least one content slot to the network accessible device.

6. The method of claim 1, in which the at least one content item displayed in the at least one content slot is transferred from a second publisher.

7. The method of claim 1, in which the at least one content item is a personalized message to the user.

8. The method of claim 1, in which revenue is paid by the user to the publisher responsive to a calculated predicted likelihood of the user clicking on an advertisement displayed in the at least one content slot in lieu of the display of the at least one content item in said slot.

9. The method of claim 1, in which the identifying step comprises performing an automated auction to select a third party content item for display in the at least one content slot and an associated amount of revenue payable for said display of the third party content item, and charging the user an amount of money associated with said revenue to display the at least one content item in lieu of the third party content item.

10. A computer implemented method comprising:
receiving, in a server memory, a request from a network accessible device to transfer at least one content item for display in at least one content slot of a content display of a publisher;
identifying at least one selected content item from a plurality of available content items;
transmitting, across a network, the at least one selected content item for display in the at least one content slot of the content display on the device; and
transferring funds from a user of the network accessible device to the publisher of the content display in an amount at least equal to an amount the publisher would have received responsive to display of a second content item in said at least one content slot.

11. The method of claim 10, in which the at least one content item is selected from a pool of available content items responsive to profile information associated with the user of the network accessible device.

12. The method of claim 10, in which the second content item is characterized as an advertisement.

13. The method of claim 12, in which the amount the publisher would have received responsive to display of the advertisement is determined responsive to an automated advertisement auction carried out by an ad server.

14. The method of claim 10, in which the at least one content item is preselected by the user.

15. The method of claim 10, in which the at least one content item is provided from a second publisher.

16. The method of claim 10, in which the amount the publisher would have received responsive to display of the second content item in said at least one content slot is determined responsive to a calculated predicted likelihood of the user clicking on the second content item had said item been displayed in the at least one content slot.

17. An apparatus comprising:
a content display layout engine adapted to transfer data to a network accessible device to display a content display of a publisher on said device, the content display having at least one content slot; and
a user selected content server adapted to transfer to the device an associated content item for display in the at least one content slot of the content display, the at least one content item selected by the user.

18. The apparatus of claim 17, in which the at least one content slot is further adapted to display an advertisement from an ad server, and the at least one content item is displayed in lieu of an advertisement from the ad server.

19. The apparatus of claim 17, further comprising a revenue transfer engine which identifies an amount of revenue payable to the publisher from an advertiser for display of an advertisement associated with the advertiser in the at least one content slot on the network accessible device, and transferring said amount of revenue from the user of the network accessible device to the publisher responsive to the display of the at least one content item in lieu of the advertisement.

20. The apparatus of claim 19, further comprising an ad selection engine which identifies said amount of revenue responsive to an automated advertisement auction for the at least one content slot carried out responsive to a request by the network accessible device for the content display.
